(19) United States
(12) Patent Application Publication
(10) Pub. No.: US 2005/0046272 A1
(43) Pub. Date: Mar. 3, 2005

(54) Method for carrying out an automatic braking action

(76) Inventors: Peter Rieth, Eltville (DE); Ronald Bayer, Muhlheim/Main (DE); Thomas Eberz, Frankfurt/M (DE); Alfred Eckert, Mainz-Hechtsheim (DE); Stefan Drumm, Saulheim (DE); Kurt Landau, Griesheim (DE); Bettina Abendroth, Eppertshausen (DE); Eva Bender, Modautal (DE); Markus Neumann, Gross-Zimmern (DE); Jochen Weisse, Darmstadt (DE); Knut Berg, Heppenheim (DE); Frank Rischbieter, Lehre (DE); Dieter Maus, Hohenhameln (DE); Jorg Tiemann, Konigslutter (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/488,638

(22) PCT Filed: Sep. 5, 2002
(86) PCT No.: PCT/EP02/09930

(30) Foreign Application Priority Data
Sep. 7, 2001 (DE) 101 44 049.9

(51) Int. Cl. B60T 8/34

(52) U.S. Cl. 303/113.4; 303/155

(57) ABSTRACT

The present invention relates to a method for carrying out an automatic braking action, wherein at least one quantity representative of the application of the brake pedal is determined and an automatic braking action is triggered when at least one limit value (brake pedal application limit value) of the quantity representative of the application of the brake pedal is exceeded, wherein the brake pedal application limit value is modified or the quantity representative of the brake pedal is weighted according to at least one action of the driver, in particular a detected movement of the driver's foot, prior to an application of the brake pedal of the braking action considered or prior to the considered braking action.

### TECHNICAL FIELD

The present invention generally relates to vehicle brake systems and more particularly relates to a method for carrying out an automatic braking action.

### BACKGROUND OF THE INVENTION

Systems for implementing or triggering an automatic braking action in motor vehicles are referred to as brake assistance systems or as ‘brake assist.’ The brake assist supports the driver in slowing down the vehicle in danger situations or emergency braking situations. It is necessary to increase braking pressure as quickly as possible in order to minimize the stopping distance. It is known, however, that in emergency braking situations, the average driver (normal driver) is frequently not able, or only with a delay, to introduce the necessary maximum braking pressure by way of the brake pedal. As soon as the brake assist detects an emergency braking situation, the system will hence adjust the full brake pressure at the quickest possible time if the driver reacts hesitantly.

The electronic brake assist in predominate use provides braking support on the basis of a vacuum brake booster (booster) along with an electrically activatable solenoid valve for ventilating the working chamber. The prior art brake assist system analyses each brake pedal movement the driver executes by depressing the brake pedal through the diaphragm travel of the booster. When the actuating speed derived therefrom reaches a threshold, the solenoid is actuated electrically and the maximum attainable brake force boosting is adjusted thereby. This additional force is withdrawn as soon as the driver no longer exerts force to the brake pedal, which is generally detected by means of a release switch, and when a predetermined time has lapsed since the beginning of the active braking intervention.

Another possibility of realizing a brake assist function is advisable in systems that allow an active pressure increase by independent actuation of hydraulic components of the system, in particular an electric pump. A master brake cylinder (TMC) detects a panic brake pedal application of the driver by way of the signals of a pressure sensor. When a critical pressure rise is exceeded, hydraulic (additional) pressure is generated and the driver actively assisted in braking by way of actuation of the pump.

However, these brake assist systems cannot properly ascertain an emergency braking situation until the brake pedal speed exceeds a fixed, predefined threshold.

### BRIEF SUMMARY OF THE INVENTION

An object of the invention is to improve the method for operating a brake assist system and to achieve an earliest possible detection of an emergency braking situation at a high rate of detection safety and a rapid and effective brake pressure build-up in addition.

This object is achieved by the features of the independent patent claims. Preferred embodiments are indicated in the dependent sub claims.

This object is achieved in that in a brake assist method, wherein at least one quantity representative of the application or movement of the brake pedal is determined, and an automatic braking action is triggered when at least one limit value of the quantity representative of the application of the brake pedal (brake pedal application limit value) is exceeded. It is essential for the invention that the brake pedal application limit value is variable or the quantity representative of brake pedal application is weighted. According to the invention, the brake pedal application limit value is varied and/or the quantity representative of the brake pedal application is weighted according to an action of the driver, in particular a detected movement of the driver's foot, prior to an application of the brake pedal of the braking action considered and/or prior to the proper braking action considered.

The method of the invention advantageously achieves an earliest possible adaptation for a release criterion for an automatic full brake application.

According to the invention, the situation may also be taken into account that prevails before the actual application of the brake pedal in the braking action respectively considered and or before the braking action considered. In particular, at least one previously performed ‘normal’ braking action can be analyzed and taken into consideration. In the invention, the brake pedal application limit value is modified and/or the quantity representative of the brake pedal application is correspondingly weighted according to an individual pedal application performance. The latter is detected on the basis of at least one quantity representative of the brake pedal movement, preferably at least by way of the brake pedal speed, and this quantity was determined in at least one, preferably several, previously (prior to the braking action considered) performed normal braking actions', meaning no full braking actions.

The brake assist will then adjust an increased or a maximum braking pressure when the danger situations or emergency braking situations or a driver's request for a maximum deceleration and/or a critical driving situation were detected. The said is considered as detected when one or more brake pedal application limit values (or brake pedal movement limit values) are exceeded. The modification of the limit value or a weighting of the determined brake pedal application (or brake pedal movement) according to the invention render it possible in the sense of the invention to also consider the situation that prevailed before the application of the brake pedal in the release criterion for automatic full braking.

It is arranged for in the invention that a defined brake pedal force, a brake pedal travel, a brake pedal speed and/or a brake pedal acceleration, preferably a defined brake pedal speed or a quantity derived therefrom, is used as a brake pedal application limit value. It has proven that these quantities of the brake pedal movement or the brake pedal application advantageously represent relatively reliable criteria for detecting danger situations or emergency braking situations or a driver's request for maximum deceleration and/or a critical driving situation.

Preferably, a defined brake pedal speed and/or a quantity derived therefrom is used as a brake pedal movement limit value, and especially a actuating speed of the brake pedal exceeding 50 mm/s, preferably exceeding 150 mm/s, is predetermined as a brake pedal speed limit value. These limit values render it possible to early and safely distinguish an emergency braking from an uncritical ‘usual’ braking action. Favorably, a dependency of the brake pedal speed on the brake pedal travel or the quantity derived therefrom is also considered.

The invention provides that at least one brake pedal application limit value is modified according to at least one driver action, especially the movement of the driver's foot, before touching the brake pedal. Due to a modification of the limit value or weighting of the quantity representative of the brake pedal application, it is possible to adapt the brake assist at a very early point of time to a possibly prevailing emergency braking situation.

It is arranged for in the invention that at least one brake pedal application limit value is modified according to at least one detected accelerator pedal application, in particular an accelerator pedal return speed, an accelerator pedal acceleration, an accelerator pedal jerk, an accelerator pedal performance and/or an accelerator pedal performance variation. It has shown that these accelerator pedal applications represent useful criteria for possible danger situations or emergency braking situations or a driver's request for maximum deceleration, and/or a critical driving situation.

The brake pedal application limit value is changed according to the invention when there was detected an accelerator pedal return speed higher than 20 mm/s, preferably higher than 50 mm/s, an accelerator pedal acceleration exceeding 500 mm/s², preferably exceeding 1500 mm/s², an accelerator pedal jerk exceeding 20000 mm/s³, preferably exceeding 100000 mm/s³, an accelerator pedal performance exceeding 100000 mm²/s³ and/or an accelerator pedal performance variation exceeding 100000000 mm²/s⁴. It was found that these limit values provide an early indication of a possible full braking or emergency braking operation.

It is arranged for in the invention that at least one brake pedal application limit value is modified in accordance with a sensed time of shifting the foot from the accelerator pedal to the brake pedal, a foot-shift acceleration, an acceleration of return of the foot from the accelerator pedal and/or an acceleration of its approach towards the brake pedal, with the foot-shift time, foot-shift speed and/or foot-shift acceleration being preferably detected by an end position of an electronic accelerator pedal and the commencement of the application of the brake pedal. These parameters allow determining another indication of an emergency braking or full braking situation.

The brake pedal application limit value is modified according to the invention when a foot-shift time is shorter than 0.2 s, preferably shorter than 0.1 s, a foot-shift acceleration exceeds 200 cm/s², preferably exceeds 800 cm/s², an acceleration of return of the foot from the accelerator pedal exceeds 500 cm/s², preferably exceeds 1000 cm/s^{2,} and/or an acceleration of the foot's approach towards the brake pedal exceeds 200 cm/s², preferably exceeds 1000 cm/s². These limit values permit relatively detecting a suspected emergency braking or full braking situation.

The object is also achieved because in a method for implementing an automatic braking action, wherein at least one quantity representative of the application of the brake pedal is determined and an automatic braking action is triggered when at least one limit value (brake pedal application limit value) of the quantity representative of the application of the brake pedal is exceeded, in particular inhering the previously described features of the invention, the braking pressure is increased in several steps, preferably in three steps, when the automatic braking action is introduced or executed. The expression ‘braking pressure’ has a very broad meaning in this respect. According to the invention, said meaning also covers all derivable quantities such as brake torque, braking force or vehicle deceleration, which lead to a slowing down of the vehicle due to brake application. The stepwise braking pressure build-up permits triggering and controlling the automatic braking action in a way as efficient, yet also comfortable, as possible.

According to the invention, ‘suspected’ danger situations or emergency braking situations or a suspected driver's request for maximum deceleration and/or a critical driving situation are determined on the basis of at least one driver action, in particular a detected movement of the driver's foot, before an application of the brake pedal of the braking action considered and/or before the braking action considered. The term ‘suspected danger situations or emergency braking situations or a suspected driver's request for maximum deceleration and/or a critical driving situation’ according to the invention implies the likelihood of danger situations or emergency braking situations or a driver's request for maximum deceleration and/or a critical driving situation.

The braking pressure is increased in several steps in the invention according to the detection probability or detection accuracy of the suspected danger situations or emergency braking situations or the driver's request for maximum deceleration and/or the critical driving situation. Thus, the assistance given to the driver by the brake assist in conformity to the detection situation prevailing, is conformed to a danger or emergency braking, whereby the comfort and efficiency are increased.

It is arranged for in the invention that suspected danger situations or emergency braking situations or a driver's request for maximum deceleration and/or a critical driving situation are determined on the basis of at least one driver action, preferably the movement of a driver's foot, in particular the ‘braking foot’, prior to touching or applying the brake pedal. An early adaptation of the driver assistance is possible by detecting suspected danger situations or emergency braking situations or a driver's request for maximum deceleration and/or a critical driving situation before the contact or application of the brake pedal.

The invention provides that suspected danger situations or emergency braking situations or a driver's request for maximum deceleration and/or a critical driving situation are determined on the basis of a sensed time of foot-shift from the accelerator pedal to the brake pedal, a foot-shift acceleration, an acceleration of return of the foot from the accelerator pedal and/or an acceleration of its approach towards the brake pedal. It has shown that these movements of the driver's foot allow detecting the suspicion.

According to the invention, suspected danger situations or emergency braking situations or a driver's request for maximum deceleration and/or a critical driving situation are determined when a quick return of the accelerator pedal, preferably an acceleration of return from the accelerator pedal exceeding 500 cm/s², a quick shift movement of the driver's foot from the accelerator pedal to the brake pedal, preferably a foot-shift time shorter than 0.1 s or a foot-shift acceleration exceeding 800 cm/s², and/or a relatively quick approach of the driver's foot towards the brake pedal, preferably an acceleration of approach towards the brake pedal exceeding 1000 cm/s² is detected. It has shown that the suspicion can be reliably detected when these limit values are taken into consideration.

It is arranged for by the invention that the vehicle brakes are preconditioned by overcoming the clearances and applying the brake pads to the brake disc and/or drums and, possibly, build-up of a very low braking pressure of up to 2 bar approximately, when suspected danger situations or emergency braking situations or a driver's request from maximum deceleration and/or a critical driving situation was determined, that the braking pressure is increased to a low pressure value, preferably to a braking pressure of roughly 2 bar to roughly 5 bar when suspected danger situations or emergency braking situations or the driver's request for maximum deceleration and/or the critical driving situation are continuously detected, and that the braking pressure is increased to a high pressure value, preferably to a maximum braking pressure and in particular at a maximum braking pressure build-up speed when the suspicion is considered as confirmed and danger situations or emergency braking situations or a driver's request for maximum deceleration and/or a critical driving situation were detected on account of the brake pedal movement or application initiated by the driver, in particular the brake pedal speed and/or quantities derived therefrom. This permits achieving a high degree of ‘braking comfort’ for the driver and a safe automatic braking of the vehicle in the sense of a brake assist intervention.

Consequently, the above object is achieved by a method for implementing an automatic braking action comprising the following steps:

Detecting and evaluating a situation before application of the brake pedal by the driver,

preconditioning the vehicle brakes, in particular overcoming the clearances and applying the brake pads to the brake disc and/or drums and, as the case may be, build-up of a very low braking pressure of 1 to maximally 2 bar, which does not cause any noticeable vehicle deceleration, when an indication or a suspicion of a driver's request for a defined deceleration and/or a critical driving situation was detected,

continuous detecting and evaluating a situation before application of the brake pedal by the driver,

generating a very low braking pressure, preferably 2 -5 bar approximately, which causes a very insignificant, hardly noticeable vehicle deceleration when an indication or a suspicion of a driver's request for a defined deceleration and/or a critical driving situation was continuously detected,

scanning or detecting and evaluating the pedal movement of the brake pedal initiated by the driver, in particular the pedal speed or quantities derived therefrom,

generating the increased braking pressure with preferably maximum braking pressure increase speed when a driver's request for a maximum deceleration and/or a critical driving situation was detected on account of the pedal movement of the brake pedal initiated or executed by the driver.

The braking pressure build-up for the automatic braking of the vehicle is favorably generated by an active booster or by means of a hydraulic pump. The use of the invention method is especially advantageous in a brake-by-wire brake system, wherein the braking pressure is generated by means of auxiliary energy, the brake pedal is coupled to a pedal travel simulator and the auxiliary energy source is controlled electronically in accordance with brake pedal application. In this brake system it is technically very simply, safely and precisely possible to realize the brake assist in the sense of the invention by means of a corresponding actuation of the auxiliary energy source or the brake-by-wire brake system.

### BRIEF DESCRIPTION OF THE DRAWING

FIG. 1 is a graph depicting the graded automatic application of braking pressure according to the invention.

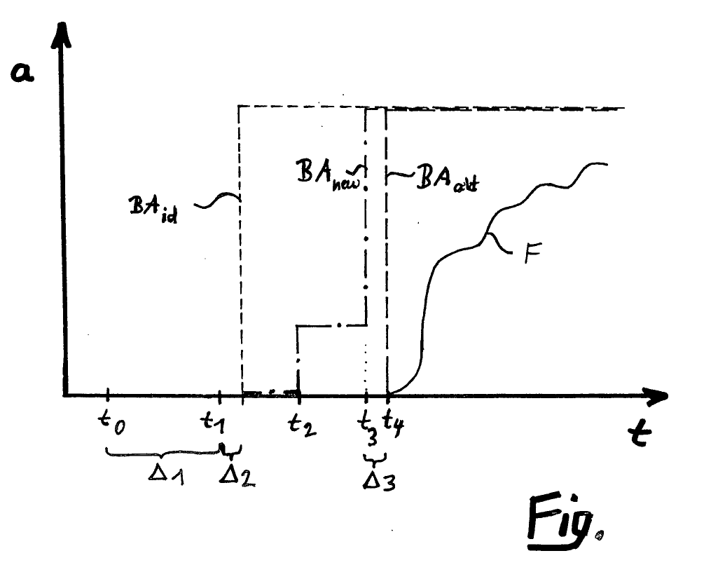

### DETAILED DESCRIPTION OF THE PREFERRED EMBODIMENTS

The resultant vehicle deceleration a is plotted against time t in the Figure for a vehicle deceleration F (solid line) that is triggered by the driver alone, an automatic vehicle deceleration by an ideal brake assist BA_{id} (line with short dashes), an automatic vehicle deceleration by a brake assist BA_{old} of the state-of-the-art (line with long dashes) as well as an automatic vehicle deceleration by a brake assist BA_{new} of the invention (dash-and-dot line). The event that triggers full braking (critical driving situation) takes place at time t_{0.} After a defined reaction time Δ_{1,} the movement of the accelerator pedal, that means a return movement of the accelerator pedal, starts at time t₁. If it were possible to detect the driver's request for full braking at this point of time, the braking pressure could be built up as quickly as possible, after a defined response time of the brake Δ₂, and the vehicle could be decelerated according to curve BA_{id}. The curves of the vehicle deceleration by means of the brake assist are represented in a schematic and ideal fashion herein and in the other curves BA_{old}, BA_{new}.

With the conventional brake assist, it is possible to automatically initiate full braking only commencing at time t₃ starting with which a quick brake pedal application by the driver and the request for a maximum deceleration can be detected. Initially, the response time of the brake Δ₃ must still be overcome for braking pressure build-up in order to displace brake fluid volumes, overcome the clearances, and apply the brake pads to the disc or drum, in particular in hydraulic systems.

The invention renders it possible to find out the probability that a ‘suspicion’ of an emergency braking situation exists commencing at time t₁. Therefore, the clearances can be overcome and so low a braking pressure may maximally be applied that decelerates the vehicle in a way unnoticeable to the driver at that time already. However, if starting from time t₂ the suspicion of the emergency braking situation is continuously detected, that means if an emergency braking situation is further likely, a defined pilot pressure, preferably some bar braking pressure, such as 2 to 10 bar, preferably 2 to 5 bar, in particular roughly 3 bar, will already be built up, whereby the vehicle decelerates already noticeably, yet only weakly. It is, however, possible at any time to discontinue the braking pressure build-up if the suspicion proves wrong, that means if the probability of the emergency braking situation reduces again, in that the driver e.g. applies the accelerator pedal again.

If, on the other hand, there is a still relatively great likelihood of subsequent full braking, it is possible to initiate full braking—based on the already prevailing braking pressure—already at the commencement of the brake pedal movement starting with time t₃ upon application of the brake pedal. This feature not only shortens the response time of brake Δ₃. Also, a defined vehicle deceleration has already occurred. Admittedly, the even relatively low braking pressure has only a relatively low vehicle deceleration as a result, but it has a major influence on the stopping distance. With a brake system that is ‘preconditioned’ this way, the stopping distance can be shortened to a relatively great extent. When the emergency situation for full braking was detected correctly, the driver will not assess the minor vehicle deceleration until time t₂ as a loss in comfort. As the method of the invention, on the other hand, provides a very high rate of safety of detecting the emergency situation, a noticeable vehicle deceleration, even if no automatic full braking or strong deceleration follows subsequently, becomes noticeable to the driver only very rarely, this means, in tolerable exceptional cases.

The invention will now be explained in detail by way of an embodiment.

To improve the function of the brake assist system, the limit values or switching thresholds of the brake assist are adapted also with respect to the driver's actions before the contact with the brake pedal in addition to a dependency on the driving speed and the brake pedal travel. In particular, the speed limit values (speed thresholds) of the brake assist are reduced as soon as the driver's actions indicate full braking or emergency braking. A quick return of the accelerator pedal, a quick shift of the driver's foot from the accelerator pedal to the brake pedal, and a quick approach of the driver's foot towards the brake pedal are considered as a driver's action indicative of an emergency braking action. The modification of the switching thresholds of the brake assist due to the detected driver action prior to a braking operation is of a temporary nature.

The modification is made smaller as a function of time. To detect the driver actions indicative of an emergency braking, proximity sensors in the brake pedal, light barriers or cameras in the leg room and at least one detection device for the accelerator pedal position can be used alternatively and in combination. However, there is at least provision of a sensing device for the non-actuated accelerator pedal position. It is favorable in terms of costs in vehicles equipped with an electronic accelerator pedal (E-gas) to use the already provided signal for the accelerator pedal position as additional information of the brake assist improved according to the invention. Additional sensors, such as light barriers, proximity switches and end position switches are not necessary in this preferred configuration.

In another embodiment of the brake assist of the invention, braking operations are actively triggered before the driver touches the brake pedal. Expecting a subsequent braking operation by the driver, this correspondingly ‘extended’ brake assist can initiate an automatically triggered braking action, preferably at an only low braking pressure to begin with. Subsequent to this action, automatic braking and braking by the driver can be superimposed upon each other similar to current practices employed in the brake assist in the art. As a basic feature, this embodiment provides a graded intensity of the actively (automatically) introduced braking actions, and the grading is varied according to an estimated ‘import’ of the expected emergency braking situation, this means an expected necessary intensity of deceleration, and the likelihood or detection safety, e.g. by way of a probability coefficient. The grading in dependence on the intensity and detection safety is carried out continuously, and the grading is feasible according to the current situation in the direction of a higher braking pressure or lower braking pressure. The estimated ‘import’ of the expected emergency braking situation is preferably determined in accordance with the accelerator pedal speed, the accelerator pedal position and the speed of the driver's foot at selected measurement positions in the leg chamber and by way of the speed at which the foot lifts from the accelerator pedal, its speed of approach towards the brake pedal and the time of foot-shift from the accelerator pedal to the brake pedal. A probability coefficient indicates how probable the expected emergency braking situation is. The values determined are weighted and assessed in that a detected high speed of approach towards the brake pedal results in a higher increase of the probability coefficient than a detected high return speed of the foot from the accelerator pedal. It applies in general that emergency braking is more likely to follow events indicative of emergency braking situations to be expected towards the end of the shift phase of the driver's foot with a greater likelihood than events at the beginning of or prior to the shift process. Therefore, the probability coefficient—beside the type of the detected events—is also evaluated especially according to the time period, how long the individual events are already ago. For example, a quick return of the accelerator pedal is initially linked to a defined probability value which decreases with the time in which no further event relevant for an emergency braking action takes place, continuously or in steps (what is advantageous for a software program) and becomes zero after lapse of a predetermined interval.

After grading the intensity of the actively initiated braking action, a nominal braking pressure is predetermined that is converted into an actual braking pressure by the extended brake assist, e.g. with the aid of an active vacuum brake booster. In an emergency braking situation expected with only little likelihood, initially a low pressure, e.g. 2 bar, is applied to the brakes. This causes the brake pads to move to bear against the friction surfaces of the brakes. The clearance of the brakes is overcome, with the result that the driver will find a preconditioned brake with minimized lost travels in the subsequent brake application. When the emergency braking is most probable to be expected, the vehicle can be decelerated distinctly already in the shift phase of the driver's foot, thereby saving precious meters of stopping distance.

Thus, the invention enhances the efficiency of the brake assist system. It is possible to achieve an early triggering and an improved security of correctly detecting emergency situations.

1-14. (Canceled)

15. Method for carrying out an automatic braking action, comprising the steps of:
determining a quantity representative of the application of the brake pedal,
triggering an automatic braking action when at least one limit value of the quantity representative of the application of the brake pedal is exceeded,
varying the brake pedal application limit value or,
weighting quantity representative of the brake pedal application according to an action of the driver prior to an application of the brake pedal of the braking action considered or prior to the proper braking action considered.

16. Method as claimed in claim 15, wherein a defined brake pedal force, a brake pedal travel, a brake pedal speed, or a brake pedal acceleration is used as a brake pedal application limit value.

17. Method as claimed in claim 15, wherein an actuating speed of the brake pedal exceeding 50 mm/s is predetermined as a brake pedal speed limit value.

18. Method as claimed in claim 15, wherein at least one brake pedal application limit value is modified according to at least one driver action before the driver touches the brake pedal.

19. Method as claimed in claim 15, wherein at least one brake pedal application limit value is modified according to at least one sensed accelerator pedal application.

20. Method as claimed in claim 15, further comprising the steps of:
modifying the brake pedal application limit value to at least one sensed accelerator pedal application, wherein at least one brake pedal application limit value is changed when an accelerator pedal return speed higher than 20 mm/s is detected, an accelerator pedal acceleration exceeding 500 mm/s² is detected, an accelerator pedal jerk exceeding 20000 mm/s³, an accelerator pedal performance exceeding 100000 mm²/s³ is detected, or an accelerator pedal performance variation exceeding 100000000 mm²/s⁴ is detected.

21. Method as claimed in claim 15, wherein at least one brake pedal application limit value is modified in accordance with a sensed time duration taken by the driver to shift the driver's foot from the accelerator pedal to the brake pedal, a foot-shift acceleration, an acceleration of return of the foot from the accelerator pedal, or an acceleration of the foot's approach towards the brake pedal.

22. Method as claimed in claim 15, the method further comprising the step of:
modifying one brake pedal application limit value in accordance with a sensed time of shifting the foot from the accelerator pedal to the brake pedal, a foot-shift acceleration, an acceleration of return of the foot from the accelerator pedal, or an acceleration of the foot's approach towards the brake pedal, wherein at least one brake pedal application limit value is modified when a foot-shift time is shorter than 0.2 s, a foot-shift acceleration exceeds 200 cm/s², an acceleration of return of the foot from the accelerator pedal exceeds 500 cm/s², or an acceleration of the foot's approach towards the brake pedal exceeds 200 cm/s².

23. Method as claimed in claim 15, further including the step of:
determining a suspected danger situation or emergency braking situation on the basis of a driver action before an application of the brake pedal or before the considered braking action.

24. Method as claimed in claim 15, further including the step of:
determining a suspected danger situation or emergency braking situation on the basis of a driver action before an application of the brake pedal or before the considered braking action, wherein the automatic braking action is executed in accordance with a detection likelihood or detection accuracy of the suspicion or the danger situations or emergency braking situations.

25. Method as claimed in claim 15, further including the step of:
determining a suspected danger situation on the basis of a driver action before an application of the brake pedal or before the considered braking action, wherein the automatic braking action is executed in accordance with a detection likelihood or detection accuracy of the suspicion or the danger situations or emergency braking situations, and wherein suspected danger situations or emergency braking situations are determined on the basis of a sensed time of foot-shift from the accelerator pedal to the brake pedal, a foot-shift acceleration, an acceleration of return of the foot from the accelerator pedal and/or an acceleration of the foot's approach towards the brake pedal.

26. Method as claimed in claim 15, further including step of:
determining a suspected danger situations or emergency braking situation on the basis of a driver action before an application of the brake pedal or before the considered braking action, wherein the automatic braking action is executed in accordance with a detection likelihood or detection accuracy of the suspicion or the danger situations or emergency braking situations, and wherein suspected danger situations or emergency braking situations are determined on the basis of a sensed time of foot-shift from the accelerator pedal to the brake pedal, a foot-shift acceleration, an acceleration of return of the foot from the accelerator pedal or an acceleration of the foot's approach towards the brake pedal, wherein suspected danger situations or emergency braking situations are determined when a quick return of the accelerator pedal, a quick shift movement of the driver's foot from the accelerator pedal to the brake pedal, and/or a relatively quick approach of the driver's foot towards the brake pedal is sensed.

27. Method as claimed in claim 15, further including the step of:
determining a suspected danger situation or emergency braking situation on the basis of a driver action before an application of the brake pedal or before the considered braking action, and wherein the automatic braking action is executed in accordance with a detection likelihood or detection accuracy of the suspicion or the danger situations or emergency braking situations, wherein the vehicle brakes are preconditioned by overcoming the clearances and applying the brake pads to the brake disc and/or drums and, as the case may be, build-up of a very low braking pressure of up to 2 bar approximately, when suspected danger situations or emergency braking situations were determined, and wherein the braking pressure is increased to a low pressure value when suspected danger situations or emergency braking situations are continuously detected, and wherein the braking pressure is increased to a high pressure value when the suspicion is considered as confirmed and danger situations or emergency braking situations are considered as detected on account of the brake pedal movement initiated or executed by the driver.

28. Method for implementing an automatic braking action, comprising the steps of:
determining quantity representative of the application of the brake pedal, and
triggering an automatic braking action when at least one limit value of a quantity representative of the application is exceeded, wherein the brake pressure is increased in several steps, for executing the automatic braking action.

29. Method as claimed in claim 28, further including the step of:
determining a suspected danger situation or an emergency braking situation on the basis of a driver action before an application of the brake pedal or before the considered braking action.

30. Method as claimed in claim 28, further including the step of:
determining a suspected danger situation or an emergency braking situation on the basis of a driver action before an application of the brake pedal or before the considered braking action, wherein the automatic braking action is executed in accordance with a detection likelihood or detection accuracy of the suspicion or the danger situations or emergency braking situations.

31. Method as claimed in claim 28, further including the step of:
determining a suspected danger situation or an emergency braking situation on the basis of a driver action before an application of the brake pedal or before the considered braking action, wherein the automatic braking action is executed in accordance with a detection likelihood or detection accuracy of the suspicion or the danger situations or emergency braking situations, wherein suspected danger situations or emergency braking situations are determined on the basis of a sensed time of foot-shift from the accelerator pedal to the brake pedal, a foot-shift acceleration, an acceleration of return of the foot from the accelerator pedal and/or an acceleration of the foot's approach towards the brake pedal.

32. Method as claimed in claim 28, further including the step of:
determining a suspected danger situation or an emergency braking situations on the basis of a driver action before an application of the brake pedal of or before the considered braking action, wherein the automatic braking action is executed in accordance with a detection likelihood or detection accuracy of the suspicion or the danger situations or emergency braking situations, and wherein suspected danger situations or emergency braking situations are determined on the basis of a sensed time of foot-shift from the accelerator pedal to the brake pedal, a foot-shift acceleration, an acceleration of return of the foot from the accelerator pedal or an acceleration of the foot's approach towards the brake pedal, wherein suspected danger situations or emergency braking situations are determined when a quick return of the accelerator pedal, a quick shift movement of the driver's foot from the accelerator pedal to the brake pedal, or a relatively quick approach of the driver's foot towards the brake pedal is sensed.

33. Method as claimed in claim 28, further including the step of:
determining a suspected danger situation or an emergency braking situation on the basis of a driver action before an application of the brake pedal of or before the considered braking action, wherein the automatic braking action is executed in accordance with a detection likelihood or detection accuracy of the suspicion or the danger situations or emergency braking situations, wherein the vehicle brakes are preconditioned by overcoming the clearances and applying the brake pads to the brake disc or drums and build-up of a very low braking pressure of up to 2 bar approximately, when suspected danger situations or emergency braking situations are determined, and wherein the braking pressure is increased to a low pressure value when suspected danger situations or emergency braking situations are continuously detected, and wherein the braking pressure is increased to a high pressure value when the suspicion is considered as confirmed and danger situations or emergency braking situations are considered as detected on account of the brake pedal movement initiated or executed by the driver.

34. Method for implementing an automatic braking action, wherein at least one quantity representative of the application of the brake pedal is determined, and an automatic braking action is triggered when at least one limit value (brake pedal application limit value) of the quantity representative of the application is exceeded, wherein the brake pressure is increased in several steps, preferably in three steps, for executing the automatic braking action as claimed in claim 15, wherein the brake pressure is increased in several steps, for executing the automatic braking action.
